(19) United States
(12) Patent Application Publication
(10) Pub. No.: US 2009/0276336 A1
(43) Pub. Date: Nov. 5, 2009

(54) Methods and Systems for Self-Branding Through E-Commerce Channels, Establishing a Virtual Storefront, and Procuring Self-Branded Merchandise for Sale Therein

(75) Inventor: Alex Rosales, Westmount (CA)

Correspondence Address: KALOW & SPRINGUT LLP, 488 MADISON AVENUE, 19TH FLOOR, NEW YORK, NY, 10022, US

(73) Assignee: Ibelis Corporation, Montreal (CA)

(21) Appl. No.: 12/434,110

(22) Filed: May 1, 2009

Related U.S. Application Data
(60) Provisional application No. 61/049,635, filed on May 1, 2008.

(51) Int. Cl. G06Q 30/00; G06Q 10/00; G06K 9/36

(52) U.S. Cl. 705/27; 705/28; 382/284

(57) ABSTRACT

Methods and systems are provided for the creation and management of online businesses (e-Business). The methods and systems automate key business processes and enable intelligent business control. Through the use of the present invention, each e-Business can offer its own branded products for sale without having to maintain an inventory of such products.

### CROSS REFERENCE TO RELATED APPLICATION

This application claims the benefit of the filing date of U.S. Provisional Application Ser. No. 61/049,635, filed May 1, 2008, the entire disclosure of which is incorporated by reference as if set forth fully herein.

### FIELD OF THE INVENTION

The present invention relates to the field of branding of goods for sale in e-commerce.

### BACKGROUND OF THE INVENTION

Engaging in electronic business (e-Business) is defined as leveraging the Internet for providing or sharing information, or for delivering services, and/or realizing some or all of a company's revenues from Internet based transactions and/or the manufacture and sale of Internet-related products or services. In addition to online purchases and transactions, a successful e-Business needs to engage in portfolio management, business planning, and Internet or intranet-based communication between itself and its clients, its suppliers and its other partners. These can pose significant hurdles to persons who wish to operate e-Businesses.

Thus, the market is in the need of an inexpensive package solution for people who want to start and to run their own online businesses. Accordingly, there is a need for a package solution that provides the user with a plurality of the following: the ability to uses its own business brand name, the ability to market its own line of products, and the technology independence to successfully develop, test and release its own business online without unnecessary dependencies.

### SUMMARY OF INVENTION

The present invention provides computer systems and methods for the creation and management of e-Businesses. It automates key business processes and uses a strategy that is simple, workable and practical, which allows an online user to establish its own e-Business.

Through the various embodiments of the present invention, persons wishing to ran e-Businesses can search databases of products provided by a wide array of suppliers. These materials can be exported or otherwise sent to the e-Business client's own website or web-based storefront where the selected products may be presented with the e-Business's own branding. Orders for the products may be processed on the e-Business site while the e-Business branded products are shipped directly from the supplier. Using this model, e-Businesses can then compete with large and capital-rich businesses.

According to one embodiment, the present invention provides: a computer system for enabling the self-branding of products, said computer system comprising a central processing unit and a computer program product, wherein the central processing unit is capable of executing a set of commands that are stored in computer readable format on the computer program product, wherein said commands, when executed cause the central processing unit: (a) to receive product data, wherein said product data identifies a product for sale; (b) to store said product data in computer readable form; (c) to display said product data on a website; (d) to receive a user request, wherein said user request comprises (i) a selection of said product; (ii) an user label; and (iii) a destination; (e) to form a composite image comprised of an image of said product and said user label; (f) to transmit the image to said destination; (g) to receive an order for said product; and (h) to transmit said order to an order fulfillment center.

According to a second embodiment, the present invention provides a method for conducting e-commerce, wherein said method comprises: (a) receiving product data for a product from a supplier (or plurality of suppliers); (b) displaying said product data to a user (or a plurality of users); (c) receiving a request for a product from said user, wherein said request comprises a user identification component (also referred to as a user label), a product identification component, wherein said product identification component identifies said product, and a destination, such as a website; (d) forming a composite image that contains an image of said product and said user identification component; (e) transmitting the composite image to said destination website; (f) receiving an order for said product from a consumer; (g) verifying availability of said product; and (h) notifying a fulfillment center to deliver said product to said consumer.

According to a third embodiment, the present invention provides a computer readable storage medium for storing instructions that when executed by a computer cause the computer to cause the transmission of an order for a branded product, wherein said computer readable storage medium comprises: (a) a product data module, wherein said product data module is capable of receiving product data; (b) a storage module, wherein said storage module is capable of storing said product data and said storage module is operably coupled to said product data module; (c) a display module, wherein said display module is capable of displaying said product data over a network, wherein said network is accessible through a user interface and wherein said display module is operably coupled to said storage module; (d) a product branding module, wherein said product branding module is capable of receiving a selection of said product data, user label data, and a destination, and is capable of forming a composite image from the user label data and the product data; (e) a transmission module, wherein said transmission module is capable of transmitting to said destination, at least one of said composite image or a set of instructions for a host computer to cause said composite image to be formed, wherein said transmission module is operably coupled to said product branding module; (f) a product order module, wherein said product order module is capable of receiving an order from a consumer, wherein said order comprises a selection of a product displayed in said composite image; and (g) an order fulfillment module, wherein said order fulfillment module is capable of transmitting said order from said consumer to a product fulfillment center, wherein said order fulfillment module is operably coupled to said product order module.

Various embodiments of the present invention consolidate solutions needed to operate an online e-Business more efficiently, and provide the e-Business with an online business infrastructure. Additionally, in some embodiments, each e-Business can offer its own branded products for sale without having to maintain an inventory of such products.

### BRIEF DESCRIPTION OF THE DRAWINGS

FIG. 1 is a representation of a diagram of a computer system used in an embodiment of the present invention.

FIG. 2 is a representation of another computer system of the present invention.

FIG. 3 is a representation of a process of obtaining product data from different suppliers.

FIG. 4 is a representation of a diagram of an isolated e-business environment structure used to create an embodiment of the present invention.

### DESCRIPTION OF THE INVENTION

The present invention is directed to a computer system for the creation and management of an e-Business. Through the use of the various embodiments of the present invention, an e-Business can offer its own branded products for sale without having to maintain an inventory of such products. In order to offer these products, Business users, also known as “e-tail clients,” or “users” can search databases of products offered by a wide array of suppliers and arrange for these products to be branded with the user's chosen brand.

According to one embodiment, the present invention provides a computer system for enabling the self-branding of products. The computer system may contain a central process unit. A “central processing unit” or “CPU” is an electronic circuit that is capable of executing a set of commands that are stored in a computer readable format. Examples of CPUs include but are not limited to mainframe computers, personal computers, workstations, supercomputers, laptops, notebooks, personal digital assistants, and netbooks.

The system may also contain a computer program product that stores a set of instructions. The instructions, which may be in any computer language that is readable by the central processing unit, enable the CPU to perform a number of functions. The computer program product may exist in the form of software or hardware that is separable from or integrated into the CPU.

One functionality that the system has is the ability to receive product data. The product data is information that describes at least one characteristic of a product that an entity or person wishes to make available for branding for sale. The product data can be in the form of one or more of text or code (including but not limited to alphabetic, alphanumeric or numeric code) and can include visual components such as photographs, drawings or figures. Examples of product data contained in the text, code or images include, but are not limited to, name of the item, size, dimensions, specifications, price, a digital representation of the product, a SKU number, a serial number and availability. The product data is provided by the entity that represents that it can supply the product referenced in the data. This entity may be referred to as the “supplier.” Examples of suppliers include, but are not limited to, manufacturers, distributors, wholesalers, and vendors. In some embodiments, this information may comprise data for individual product items, including different sizes and colors for the items, as well as available inventory and cost. In other embodiments, the system can receive data for a plurality of products that are part of the same product line or unrelated products. The system is also preferably designed to be able to receive data that corresponds to a plurality of different products, and from a plurality of different suppliers.

Examples of products include, but are not limited to, books, jewelry, tools, apparel, sunglasses, toys, lighting, accessories, shoes, decorative articles, furniture, rugs, stationery, writing implements, bedding, art supplies, craft items, house wares, and cosmetics.

The system is also capable of causing the product data information to be stored in computer readable form. The storage may be on hardware and/or software. The creation and maintaining of a database capable for storing this type of information and for being searched for retrieval of this type of information are well-known by persons of ordinary skill in the relevant art.

For example, in order to collect the data from different suppliers, data about suppliers' products may be loaded into a relational database (RDBMS) using a data conversion system. The data conversion system loads data from several different formats and the data is run against a parse engine, which takes care of uploading the data into a pre-staging database. Once the suppliers' product data is loaded into the pre-staging database, the product data is converted to the generic product type and copied into the staging database.

After the information is stored, the system may cause the product data to be displayed. The product data may be displayed in the form of an image, text or combination thereof. In some embodiments, the display may be on a website that is, for example, accessible through a URL. Accompanying the display of the product data may be the source or supplier and the terms of supply, e.g., method of payment, method of shipment of goods and/or bulk discounts.

There may also be computer instructions that permit display of multiple views of the product. For example, one who views the website may be able to view a plurality if not all of the following views: front, rear, left, right, top, bottom and perspective. There may also be a functionality that permits the user to view enlarged or reduced images.

In some embodiments, the display may be accessible to third parties who wish to brand their products, also referred to as “goods.” These third parties, who may be referred to as users, may, for example, access the site over the Internet. In some embodiments, the access to the suppliers' goods available for branding may require a subscription for a fee and/or a user password. Preferably the site on which the user is able to view the suppliers' goods enables the users to easily view different goods from the same supplier and to easily view different goods from different suppliers. Displays for viewing by these users may contain images of the products without any branding, or they may contain images of samples of what products with branding would look like.

On this URL site, there may be a portal for the receipt of information or there may be a link to a separate page into which information may be entered. Among the information that the system may be configured to receive is a selection of a product, a user label and a destination to which information may be sent.

The selection of the product refers to the selection of a product that a supplier has indicated is available for branding. The “user label” refers to the brand that the user wishes to affix to the goods. In some embodiments, a user may preview an image with the brand of the goods affixed to it. The user may, in some embodiments, be able to alter the orientation of the brand, the style of the brand, the size of the brand, the location of the brand, the color of the brand, etc. Thus, the user may input information in the form of text and the system may be configured to have a functionality to offer these different options. Alternatively or additionally, the user may scan an image of the brand that it wants to use and the system will be configured to treat the scanned image as a graphic that can be affixed to the image of the product.

Although the “user label” refers to the brand to be affixed to or associated with the product, the user may in some embodiments also be asked to input its contact information. Thus, the user label may for example be a trademark, while the contact information may include the company's name, location, address, e-mail, phone number and person for contacting. The user may also be asked to provide a guaranty of payment or credit card to be used by the supplier in case moneys are due in the future or as a fee to the host of the site or as a fee for sample branded products.

With the receipt of the selection of the product and the user label, the system may cause a composite image to be formed for viewing by the user, and optionally by the supplier. In some embodiments, this image is created as soon as the user provides the requisite information. In other embodiments, the system causes the information to be created, but makes it available at a later date on the URL or by sending it to a remote location, e.g., an email address. In some embodiments, the system will store the composite image and associate with this stored information, the identity of the user, the identity of the supplier and the product. In other embodiments, the system may be designed or operated without the creation of a composite image.

A user may seek to brand a plurality of goods, and through the storage of the composite images, the user can make selections and revisit them at a later time. The composite images may be stored in the same database as the product information that the suppliers provided, or it may be stored in a different database on the same or different hardware or software as the product information that the suppliers provided.

After the image is created, a user may request that the image be sent to a destination. The image may be sent to an email destination or to a website designated by the user. If the image is sent to an email address, then the image may, for example, be in the form of a PDF, jPEG, TIF, GIF, PNJ or any other image format. If the image is sent to a website, it may also be in one of these forms. Alternatively or additionally, it may be in another form that requires an application to open it, and that application may be sent with or separately from the image. Further, in some embodiments, rather than sending the image, the system causes a set of instructions to be sent that when executed by a remote computer or server cause the image to be created. The system may have a default image format or it may require the user to select the image format before it is sent.

The website on which the image is to be displayed may, for example, have a designated location for such images. The designated location may be a separate window, a pop-up, a shadow screen, an image box, a side by side channel display, or a “window inside a window.” Further, the website may be designed such that it is prepared to receive the image and automatically uploads the image into a predesignated location. The image may also be sent with bibliographic information that can be uploaded and displayed to the public or only to the user. For example, the bibliographic information may include a price as listed by the supplier and the identity of the supplier. In some embodiments, a user may not want downstream consumers to know this price or the identity of the supplier but the user may want a confirmation of it. Accordingly, bibliographic information containing this information may be sent in a confirmation email that the consumer will not see. By contrast, information that the user may wish for the ultimate consumer to see is, for example, the profile or the dimension of a product or its size. The recipient website could be designed to have fields for this information that upon receipt of it would automatically be displayed with the image.

In some embodiments, the website on which the image is to be displayed may act as a virtual product catalog. Thus, a user may have its own website that displays a plurality of composite images that are received from the system. The user may display a plurality of images that come from a plurality of different sources. Thus, in some embodiments, the website may be accessed through its own unique URL address. In other embodiments the website may be accessed as a storefront on a communal website. Thus, a plurality of different users may offer a plurality of different products that are accessed through a communal website. The communal website may for example be operated either by the entity that operates the aforementioned system through which the users select products for branding, or it may be operated by an independent entity.

The system may also be designed to receive orders for the product. Thus, when a consumer visits the user's website or the communal website referenced above (which may or may not be hosted on the same server as the website through which the user may design the composite images), she may shop and select one or more products for purchase. This request may then be passed along to the supplier at a fulfillment center, which affixes the selected brand to the item and ships it directly to the consumer. The system may be designed such that orders that are placed are transmitted directly to the supplier and/or through the aforementioned central processing unit.

The brand may be affixed after the order is placed, or the fulfillment center may have one or more items branded prior to purchase. Thus, in various embodiments, the system of the present invention can be used to bridge contact between the supplier and the user, to bridge contact between the user and the consumer, to bridge contact between the supplier and the consumer, and to bridge contact between the user and the supplier.

The system may also have a display screen through which the consumers may shop. Because shopping is done on-line, the “stores” at which the shopping is done, may be referred to as “virtual stores.” The appearance of these stores may be designed to the specification of the user who offers its branded goods for sale or in the case of virtual stores that host a plurality of vendors (a virtual mall), to the specifications of the “virtual landlord” who hosts or operates the site. In some embodiments, the virtual storefront may have designated locations on the web pages for such images. Each designated location may be a separate window, a pop-up, a shadow screen, an image box, a side by side channel display, or a “window inside a window.”

Methods for payment for transactions over the Internet are well known to persons of ordinary skill in the art and include the supply of credit card information directly to the supplier or to a third party service provider such as PayPal.

The system may further comprise a first input device. The first input device may, for example, be selected from the group consisting of a personal computer, a cellular telephone and a personal digital assistant and is capable of transmitting the product data to the system. There may also be a second input device. The second input device may, for example, be selected from the group consisting of a personal computer, a cellular telephone and a personal digital assistant and is capable of transmitting said order for said product from the consumer. The system may also comprise a third input device that is capable of transmitting the information described above from the user to the system.

Transmission of each of the aforementioned types of information may be accomplished independently through a communication network. A communication network may be public, such as the Internet; or private, such as carrier networks, ATM (at the moment) networks and RFID networks; and gateways, such as SMS (short message service), WAP (wireless application protocol), RFID and ATM. As persons of ordinary skill are aware, a network at its most basic level is any wired or wireless form of connective technology. Each of the aforementioned input devices is preferably configured to allow seamless or easy communication with the central processing unit.

Preferably, the network is capable of transmitting data containing the information sent by the first input device and delivering it to the CPU (which may have an appropriate receiving device or connection to the network that is configured to receive or facilitates the reception of the data), and transmitting communications from the system to the network that will host the website to be viewed by the user. Preferably the network can also transmit information from the user to the system, from the system to the user, from the system to the destination site, from the consumer to the system, and from the system to the fulfillment center.

The fulfillment center refers to the supplier or the entity that the supplier designated as appropriate for receiving orders to be fulfilled and delivered to the consumer. The term “delivered” refers to physically transferring the product to the consumer, which may be accomplished by shipping, personal delivery to the consumer in a store (or other location, e.g., home) or arranging for the consumer to pick up the product at a predetermined site.

According to a second embodiment, the present invention provides methods for conducting c-commerce. In some embodiments, the methods comprise receiving product data for at least one product from at least one supplier; displaying said product data to at least one user; receiving a request for a product from said at least one user, wherein said request comprises a user identification component (also referred to as a user label), a product identification component, wherein said product identification component identifies said product, and a destination such as a website or email address; forming a composite image that contains an image of said product and said user label; transmitting the composite image to said destination website; receiving an order for said product from a consumer; and notifying a fulfillment center to deliver said product to said user.

Optionally, there may be a step of verifying the availability of the product prior to notifying the fulfillment center. When there is a verification step, verification may, for example, be accomplished by contacting the supplier and receiving confirmation of availability of the product or if the information tracking inventory is already present in the system's database, then checking that database.

In various embodiments, the system may also send a return message to the consumer that indicates whether the product is available or out of stock. Additionally, in various embodiments, the system may also send a message to the user that indicates that the order has been placed and whether the product is available or out of stock.

The term “availability” refers to the product being in inventory and accessible to the supplier. A product is considered available even if the user's label has not already been affixed to it, if the underlying good, e.g., the clothing item is obtainable (or already obtained) and the supplier can arrange to brand the item with the user's identification prior to shipment to the consumer.

According to a third embodiment, the present invention provides a computer readable storage medium for storing instructions that when executed by a computer cause the computer to cause the transmission of an order for branded products. The computer readable storage medium may comprise one or more separate modules that contain these instructions. Each module may be operably coupled to one or more other modules. The phrase “operably coupled” means that two or more devices or modules are configured such that they can communicate with or among each other and that they can each function in their designed manners when communicating.

For example, there may be a product data module, wherein said product data module is capable of receiving product data. There may also be a storage module, wherein said storage module is capable of storing said product data and said storage module is operably coupled to the product data module. Further, there may be a display module, wherein the display module is capable of displaying the product data over a network, wherein the network is accessible through a user interface and wherein the display module is operably coupled to the storage module. Still further, there may be a product branding module, wherein the product branding module is capable of receiving a selection of said product data, user label data, and a destination and is capable of forming a composite image formed from said user label data and said product data. Still further, there may be a transmission module, wherein the transmission module is capable of transmitting to the destination at least one of said composite image or a set of instructions for a host computer to cause the composite image to be formed, wherein the transmission module is operably coupled to said product branding module. Still further, there may be a product order module, wherein the product order module is capable of receiving an order from a consumer, wherein the order comprises a selection of a product displayed in the composite image. Still further there may be an order fulfillment module, wherein the order fulfillment module is capable of transmitting the order from the consumer to a product fulfillment center, wherein the order fulfillment module is operably coupled to the product order module.

The product data module is capable of receiving product data. As noted above, the product data comprises the product information that describes at least one characteristic of the product, for instance the product attributes (i.e. size, color, specifications), product base price, product description, supplier's name, or any other product characteristic. The product data can be in the form of text or code and can also include visual components such as photographs, drawings or figures.

The storage module is operably coupled to the product data module. The storage module may comprise a hardware device and/or software.

The display module is capable of displaying product data over a network. The network is preferably accessible through a user interface and the display module is operably coupled to said storage module. Thus, the display module provides a visual presentation to the user where the user can view the products that the supplier is offering.

The product branding module is capable of receiving a selection of said product data, user label data, and an indication of a destination and is capable of forming a composite image from the user label data and the product data. Thus, the composite image is an image of how the product will look with the user label. The product branding module thus enables the creating of an image of the product with the new label identity. Other branded material that may be created and associated with the product data and/or product image may include but is not limited to packaging, invoices, sales catalogues, and product brochures.

The transmission module is capable of transmitting to the destination that has been specified by the user, at least one of the composite image or a set of instructions for a host computer to cause said composite image to be formed, wherein the transmission module is operably coupled to the product branding module. The transmission module comprises programs to cause the transmission of data and optionally to verify that the data was received by the destination.

The product order module is capable of receiving an order from a consumer, wherein said order comprises a selection of a product displayed in said composite image. The product order module comprises programs to receive an order, verify the order, and process the order. It also may contain instructions that enable the collection of funds, for example credit card information or other transfer of funds directly from the consumer.

The order fulfillment module is capable of transmitting the order from the consumer to a product fulfillment center, wherein the order fulfillment module is operably coupled to said product order module. The order fulfillment module comprises programs to transmit the order data to the order fulfillment center associated with the product identifier. The order fulfillment center may be the supplier or it may be a different destination to which the order is sent. Because the supplier may not actually be the manufacturer of the branded product, the supplier can designate the order fulfillment center as the recipient of that transmission. It may also designate both itself and the order fulfillment center as the recipient.

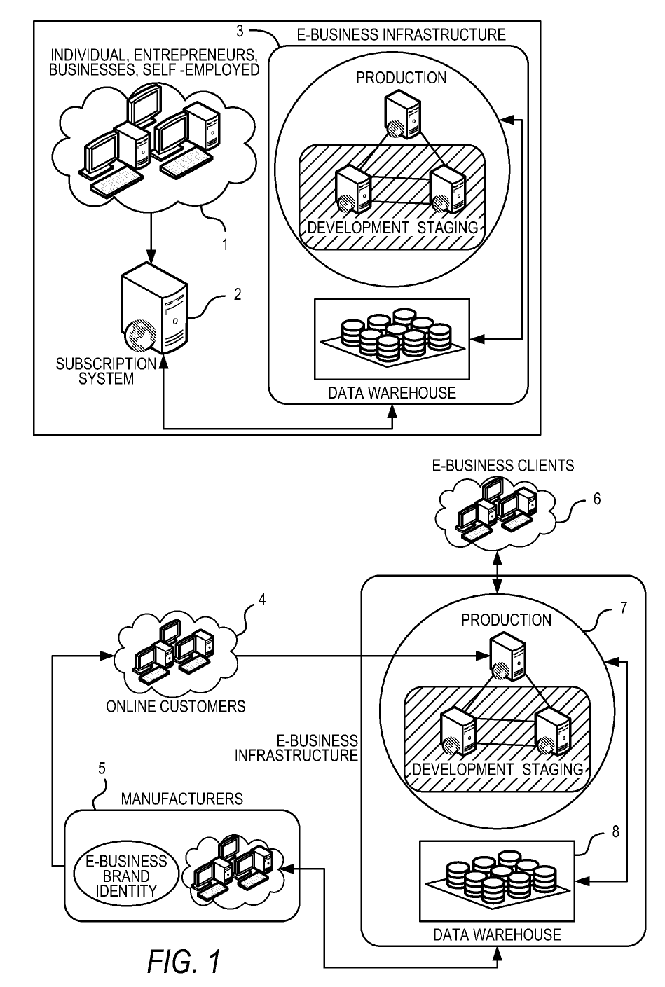

The present invention may be further understood by reference to the accompanying figures. In FIG. 1, an overview of the integration of the components used to create and manage one embodiment of an online retail business is shown. Potential users of the system, i.e., individuals, entrepreneurs, and business people 1, utilize their own computers over a network connected with the subscription system 2 where they can subscribe and gain access to the system e-Business infrastructure 3. Using the modules provided in the system infrastructure, each subscriber is able to create its own e-Business. Suppliers (referred to as manufacturers in the figure) 5 will be the party to brand products. Information from the manufacturers is transmitted to the e-Business infrastructure, which provides for the production, development and staging 7 of information, as well as maintains a data warehouse 8 that stores product data, and optionally customer (consumer) data and e-Business clients (user) data. The c-Business clients 6, access the production module 7 and supply the requisite information to form the composite images of their branded product. After these composite images are made available on the designated web-pages, the online customers, 4 access the e-Business infrastructure and place their orders, which are transmitted from the on-line customers to the e-Business infrastructure to the manufacturer 5, who then ships the items to the customers 4.

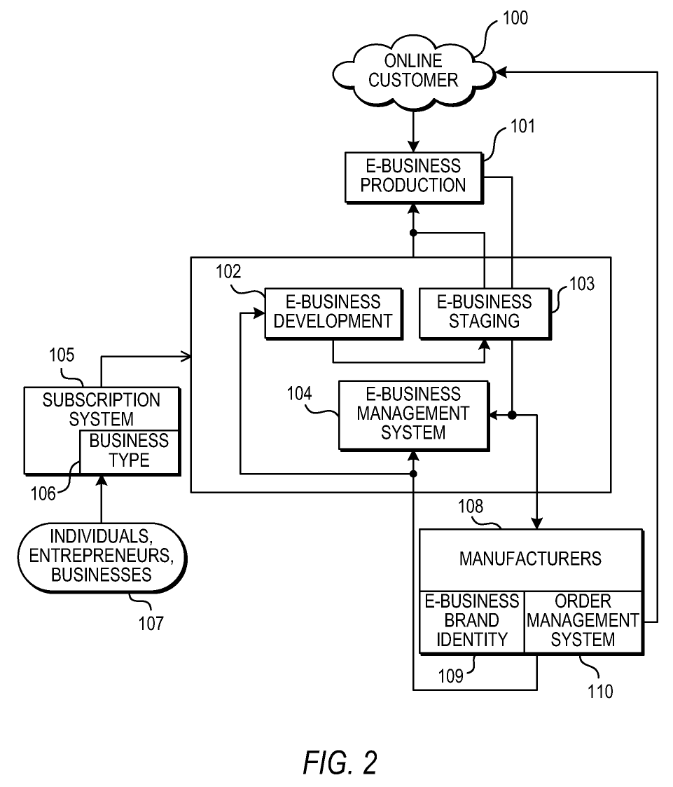

FIG. 2 presents a flow chart of the functionalities that may be utilized to create and manage an online business.

An e-Business client (individual, entrepreneur or business) 107 accesses a subscription system 105 stored on a computer or network that upon the initial accessing may ask for the types of business in which the client operates. The subscription system may also be linked to a database that stores information comprising one or more of: the business name, business location, type of business, domain information, subscription information, payment information, production information, sales information, development information, marketing information, customer service information, administration information, and financial information. The creation and maintenance of databases is within the knowledge and skill of persons of ordinary skill in the art and can, for example, be created using publicly available components such as Apache 2.0, Tomcat 5.5, Hibernate 3 and MySQL 5.

By participating in the subscription system an e-Business client gains access to an e-Business management system 104, the e-Business development module, 102, and the e-Business staging module, 103. The e-Business development module comprises a set of programs and/or instructions that allow for the creation of a development website. The e-Business staging module comprises a set of programs and/or instructions that allow for the creation of a staging website. The e-Business management module comprises a set of programs and/or instructions that allow an e-Business client to configure and manage the online business. The management module allows for the management of business areas such as production, design and development, sales, marketing, customer service, administration, finance, and general business information.

The e-Business production 101 is the resulting virtual storefront that the online consumer 100 will access and through which he may shop. The orders are processed through the e-Business management system and forwarded to the manufacturers 108, who apply the user label to establish e-Business brand identity 109 and ship the goods through their order management system 110 directly to the on-line customer.

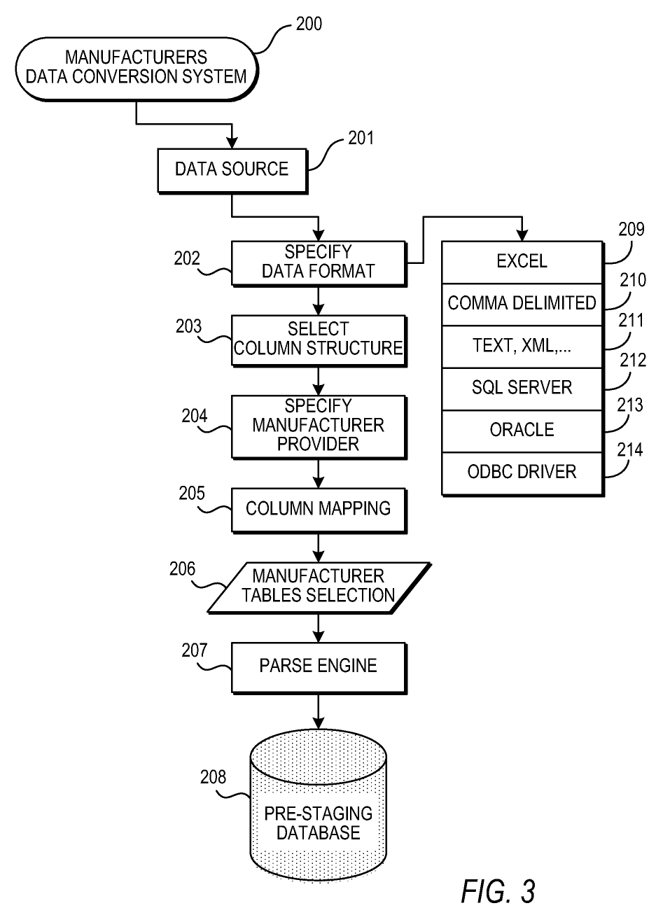

FIG. 3 is a representation of the structure of a data conversion system according to certain embodiments of the present invention. The suppliers or manufacturers' data conversion system 200 is run on its computer, which stores the supplier's electronic product inventory data and loads it into a specific format, e.g., XML. It then transmits the formatted data through a network to the main database server to provide a data source 201. The format of the data source may then be specified 202, e.g., excel 209, comma delimited 210, text or XML 211, SQL Server 212, Oracle 213, and ODBC Driver 214.

After there has been a conversion of the data into a specified format, the following parameters are established and applied: (a) select column structure 203, which allows one to load data in one of the data formats, and choose the structure into which to be converted; (b) specify manufacturer/supplier provider 204, which allows the user to specify the manufacturer/supplier company; (c) column mapping 205, which allows for the mapping of the loaded data against a specific format (e.g., XML); (d) manufacturer/supplier tables selection 206, which allows the e-Business client to select the manufacturer/supplier from a list of table names retrieved from the main database via a network; and (e) a parse engine 207, which converts the loaded data into a specific format (e.g., XML). The data conversion system connects via a network to the main database server and sends the output converted data to the pre-staging database 208. The pre-staging database is a relational database that resides on a server that stores the output converted data from the parse engine.

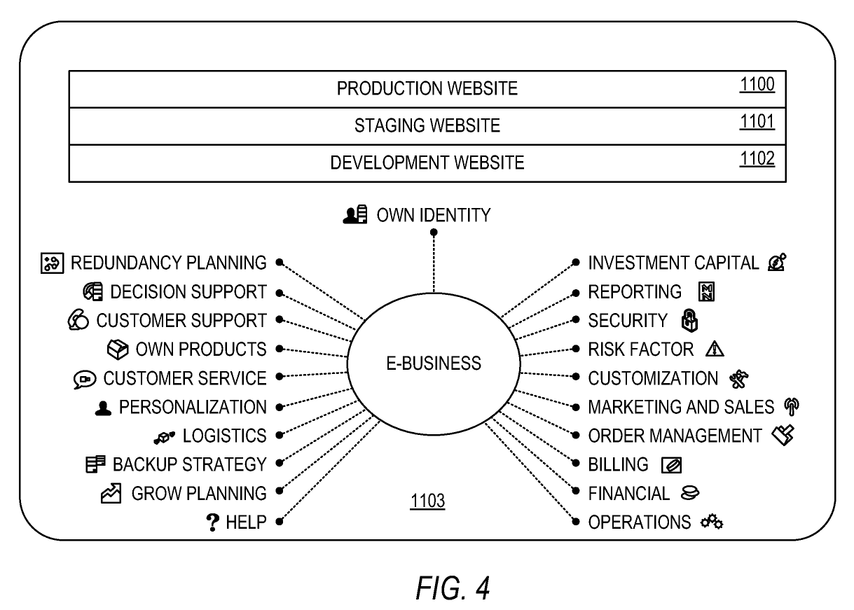

FIG. 4 is a representation of the three-tier architecture that may be used to create and manage an e-Business client's self-branded online retail business 1103. The production website 1100 is the e-Business website available on the Internet. It resides in a computer machine and is accessed by the online user through a web browser using a network system. In some embodiments, this website is not restricted. The website may be accessed by the e-Business client's unique URL address or it may be accessed as a storefront on a communal website. The staging website 1101 is a “Load and Beta Test” website. It resides in a computer and is accessed by the e-Business client through a web browser via a network system. Access to this staging website is restricted by an authentication system, which requires a login/password combination. The development website 1102 is a testing and development website. It resides in a computer and is accessed by the e-Business client through a web browser via a network system Access to this development website can be restricted by an authentication system that requires a login/password. The e-Business infrastructure 1103 comprises a set of computer programs that provides all the business tools to fully operate and manage an online business. The e-business infrastructure presents an online end-to-end system to manage an e-Business client's core business.

In alternative embodiments of the present invention, the methods and systems of may omit the step of creating the composite image and/or transmitting the composite image and/or affixing a user label to a product upon a consummation of sale. For example, the image of the product may be generic and displayed as such on a webpage that has a heading that indicates the user. Thus, no composite image needs to be formed (and similarly it would not be necessary to record the user label.) Similarly, if the user desires, in other embodiments, the vendor may ship the goods without branding them.

### Example

The following is a prophetic example and is not intended to limit the scope of the present invention in any way.

An e-Business client may visit an e-Business center website and see a product that he wants to offer. The product has a product code. The e-Business client (or user) may send a text message to a receiving device that manages his e-Business set-up. The message will include the product code indicating a desire to place the composite product information on his destination website and because it is sent from a preprogrammed text messenger device, it will also contain the e-Business client id containing the brand information (the user label).

The e-Business client continues to browse the e-Business center's website, which contains products from a number of suppliers and directs the placement of other products into the e-Business set-up. The products all permit the user label to appear in only one place and be of one size so the composite image is formed upon receipt of the selection. The e-Business center is directed to send the composite product information for the selected products to the destination website and executes the direction.

A consumer then visits the destination website and views the products offered for sale on the destination website. The consumer selects a product and places an order for purchase. The e-Business set-up transmits the order with the e-Business client id to the product supplier where the product and packaging are provided with the brand contained in the e-Business client id and ships the branded product directly to the consumer.

This application discusses specific embodiments of the present invention. The specific features described herein may be used in some embodiments, but not in others, without departing from the spirit and scope of the invention as set forth in the foregoing disclosure. It will be appreciated by those of ordinary skill in the art that the illustrative example does not define the metes and bounds of the invention. For example, the present invention should not be limited by software/program, computing environment, or specific computing hardware. Additionally, unless otherwise specified or apparent from context, each feature of each embodiment, may be used with any other embodiment.

1. A computer system for enabling the self-branding of products, said computer system comprising a central processing unit capable of executing a set of commands that are stored in computer readable format, wherein said commands, when executed cause the central processing unit:
(a) to receive product data, wherein said product data identifies a product for sale;
(b) to store said product data in computer readable form;
(c) to display said product data on a website;
(d) to receive a user request, wherein said user request comprises:
(i) a selection of said product;
(ii) an user label; and
(iii) a destination;
(e) to form a composite image comprised of an image of said product and said user label;
(f) to transmit the image to said destination;
(g) to receive an order for said product; and
(h) to transmit said order to an order fulfillment center.

2. The computer system of claim 1, wherein the product data comprises a price of said product for sale and an image of said product for sale.

3. The computer system of claim 1, wherein said composite image in is the form of a PDF, jPEG, TIF, GIF, or PNJ.

4. The computer system of claim 1, further comprising a display screen that is operably coupled to the central processing unit.

5. The computer system of claim 1 having a first input device, wherein said first input device is selected from the group consisting of a personal computer, a cellular telephone and a personal digital assistant and is capable of transmitting said product data to said central processing unit, and a second input device, wherein said second input device is selected from the group consisting of a personal computer, a cellular telephone and a personal digital assistant and is capable of transmitting said order for said product to said central processing unit.

6. The computer system of claim 1, wherein said destination is a URL.

7. The computer system of claim 1, wherein said destination is an email account.

8. The computer system of claim 1, wherein said central processing unit is capable of transmitting an application to said destination, wherein said application is capable of causing a recipient computer to be able to display said composite image.

9. A method for conducting e-commerce, wherein said method comprises:
(a) receiving product data for a product from a supplier;
(b) displaying said product data to a user;
(c) receiving a request for a product from said user, wherein said request comprises a user label, a product identification component, wherein said product identification component identifies said product, and a destination;
(d) forming a composite image that contains an image of said product and said user label;
(e) transmitting the composite image to said destination;
(f) receiving an order for said product from a consumer; and
(g) notifying a fulfillment center to deliver said product to said consumer.

10. The method according to claim 9 further comprising verifying the availability of the product prior to step (g).

11. The method according to claim 9, wherein said displaying is on a website.

12. The method according to claim 9, wherein said composite image is a PDF, jPEG, TIF, GIF, or PNJ.

13. The method according to claim 9, wherein said transmitting is over the Internet.

14. A computer program product stored in computer readable form that, when executed by a computer, causes the computer to perform the method of claim 9.

15. A computer readable storage medium for storing instructions that when executed by a computer cause the computer to cause the transmission of an order for a branded product, wherein said computer readable storage medium comprises:
(a) a product data module, wherein said product data module is capable of receiving product data;
(b) a storage module, wherein said storage module is capable of storing said product data and said storage module is operably coupled to said product data module;
(c) a display module, wherein said display module is capable of displaying said product data over a network, wherein said network is accessible through a user interface and wherein said display module is operably coupled to said storage module;
(d) a product branding module, wherein said product branding module is capable of receiving a selection of said product data, user label data, and a destination and is capable of forming a composite image formed from said user label data and said product data,
(e) a transmission module, wherein said transmission module is capable of transmitting to said destination, at least one of said composite image or a set of instructions for a host computer to cause said composite image to be formed, wherein said transmission module is operably coupled to said product branding module;
(f) a product order module, wherein said product order module is capable of receiving an order from a consumer, wherein said order comprises a selection of a product displayed in said composite image; and
(g) an order fulfillment module, wherein said order fulfillment module is capable of transmitting said order from said consumer to a product fulfillment center, wherein said order fulfillment module is operably coupled to said product order module.

16. The computer readable storage medium of claim 15, wherein said product data comprises an image of a product.
